(19) United States
(12) Patent Application Publication
(10) Pub. No.: US 2004/0169827 A1
(43) Pub. Date: Sep. 2, 2004

(54) Projection display apparatus

(76) Inventors: Mitsuo Kubo, Yokosuka-shi (JP); Masaru Watanabe, Ebina-shi (JP); Hiroshi Hayashi, Tokyo (JP)

Correspondence Address: NATH & ASSOCIATES, PLLC, Sixth Floor, 1030 15th Street, N.W., Washington, DC, 20005, US

(21) Appl. No.: 10/782,768

(22) Filed: Feb. 23, 2004

(30) Foreign Application Priority Data
Feb. 28, 2003 (JP) P2003-054422
Feb. 28, 2003 (JP) P2003-054432
Jan. 15, 2004 (JP) P2004-008247
Jan. 15, 2004 (JP) P2004-008266

(51) Int. Cl. G03B 21/00

(52) U.S. Cl. 353/94

(57) ABSTRACT

A projection display apparatus employs a plurality of projectors 1, 2, 3 and combines images from the projectors into a large composite image on a nonplanar screen such as a concave spherical screen 10. The composite image is of high quality and high resolution and is normally visible by audience. The projectors 1, 2, 3 receive video signals through a geometric conversion unit and project and display images on the nonplanar screen 10 according to the received video signals. The geometric conversion unit transforms the field angles of images to display, according to relationships among the positions of the projectors 1, 2, 3, the positions of areas of the nonplanar screen 10 to which the projectors project images, and the position of an audience, thereby compensating distortions of images caused by the nonplanar shape of the screen 10.

### FIELD OF THE INVENTION

The present invention relates to a projection display apparatus employing a plurality of projection display units to project and display images on a nonplanar screen and an adjusting apparatus to adjust an image transforming quantity for the projection display apparatus.

### BACKGROUND OF THE INVENTION

There is a projection display apparatus employing a plurality of projection display units to project and display a plurality of images side by side on a planar screen, to thereby provide a large image. To display a large image on a planar screen, the screen must be large, and therefore, it is difficult in a narrow environment to display a large image. There is an apparatus that employs a screen like the inside of a cube, to realize a sense of virtual reality. This apparatus, however, is unable to provide a perspective space or sufficient presence. There is another projection display apparatus employing a special projection lens such as a fish-eye lens to project and display an image on a curved screen having, for example, a concave spherical surface.

Still another projection display apparatus employs a plurality of projection display units to project and display a plurality of images side by side on a concave spherical screen. This apparatus provides a large image that may cover an audience. The concave spherical screen (nonplanar screen) can entirely cover the view field of an audience, and therefore, can realize an environment that makes the audience feel like seeing a large screen even with a screen of limited size. In this connection, reference is made to Japanese Patent Application Laid-Open Publication No. 2002-72359.

According to the above-mentioned projection display apparatus employing a plurality of projection display units to display a plurality of images side by side on a concave spherical screen, the projection display units involve display devices such as CRTs without pixels. This is because projecting and displaying an image from a projection display unit to a concave spherical screen causes a distortion of a displayed image. To cope with this problem, a distortion opposite to the distortion of a displayed image must be applied to the image in advance. The projection display unit without pixels can easily generate such predistortion.

The display device without pixels is restricted in arrangement, is easily affected by reflection from a screen, and is difficult to provide images of improved contrast. In particular, the display device without pixels has a problem with a concave spherical screen due to the arrangement of the display device, the problem being that reflected light affects the screen to deteriorate the contrast of images on the screen. A projection display apparatus employing projection display units that involve display devices such as liquid crystal display (LCD) panels with pixels allows the projection display units to be arranged more freely to display a composite image. This results in preventing a reduction in the contrast of images due to screen reflection.

Projecting an image to a nonplanar screen from a projection display unit employing the display device with pixels has been achievable only with the use of an optical lens (in particular, a fish-eye lens). Namely, combining images projected from a plurality of projection display units each employing the display device with pixels into a composite image has been realizable only on a planar screen. When the projection display units employing the display devices with pixels are used to display a large composite image on a concave spherical screen (nonplanar screen), the composite image will be deformed on the curved screen to provide an abnormal image for an audience. There is no related art that is capable of projecting and displaying high-quality, high-resolution images on a concave spherical screen (nonplanar screen).

### SUMMARY OF THE INVENTION

In consideration of the situation mentioned above, an object of the present invention is to provide a projection display apparatus capable of combining images displayed by a plurality of projection display units into a large composite image even on a nonplanar screen such as a concave spherical screen, the composite image being of high quality and high resolution and being normally visible by audience. The present invention also provides an adjusting apparatus to adjust images for the projection display units.

In order to accomplish the objects, an aspect of the present invention provides a projection display apparatus having a plurality of projection display units configured to project and display images based on supplied video signals, a nonplanar screen to which the projection display units project the images, an image dividing unit configured to divide an incoming video signal into divided video signals for the projection display units, respectively, and image transforming means. The image transforming means are configured to change the field angle of images represented with the divided video signals according to relationships of the position of the corresponding projection display units, the position of areas of the nonplanar screen to which the corresponding projection display units project the images, and the position of an audience. Each of the projection display units receives the changed video signal from the image transforming means and projects an image to the nonplanar screen according to the received video signal. This projection display apparatus is capable of displaying high-quality, high-resolution images that are normally visible by audience.

Preferably, the image transforming means comprise image transforming units, the image transforming units provided for the projection display units, respectively. Preferably, each of the image transforming units is configured to change the field angle of an image represented with the corresponding divided video signal according to relationships among the position of the corresponding projection display unit, the position of an area of the nonplanar screen to which the corresponding projection display unit projects the image, and the position of an audience. Preferably, each of the projection display units receives the changed video signal from the corresponding image transforming unit and projects an image to the nonplanar screen according to the received video signal.

According to another aspect of the present invention, the nonplanar screen corresponds to an inner wall surface of a substantial hemisphere, and the projection display units are arranged in the vicinity of the center of curvature of the nonplanar screen, or on a straight line passing through the center of curvature of the nonplanar screen and the center of the nonplanar screen. This aspect may minimize repetitive reflection on the nonplanar screen and maintain the contrast of displayed images.

According to still another aspect of the present invention, each of the image transforming means have a frame memory configured to store the divided video signals, a positional information memory configured to store positional information of pixels, and a digital filtering data memory configured to read video signals from the frame memory and store the read video signals. The image transforming means sequentially write the divided video signals in the frame memory, store new positional information for pixels to convert in the positional information memory, and according to the new positional information in the positional information memory, transfer as and when needed video signals related to regions used for digital filtering from the frame memory to the digital filtering data memory.

For a projection display apparatus having projection display units to project and display images according to a supplied video signals, a nonplanar screen to which the projection display units project the images, and an image transforming means to change the field angle of images to display according to relationships of the position of the projection display units, the position of areas of the nonplanar screen to which the projection display units project the images, and the position of an audience, still another aspect of the present invention provides an adjusting apparatus for adjusting an image transforming quantity of the image transforming means. The adjusting apparatus involves an adjustive signal generator configured to generate an adjustive signal according to which the projection display units project adjustive images to the nonplanar screen, a plurality of photographing units configured to photograph the projected adjustive images, a measuring unit configured to three-dimensionally measure the projected adjustive images according to video signals provided by the photographing units, and a transformation processor configured to provide the image transforming means with image transforming information based on a measurement result provided by the measuring unit. According to this aspect, the adjusting apparatus allows the projection display apparatus to display high-quality, high-resolution images that are normally visible by audience.

Still another aspect of the present invention supports the plurality of photographing units on a common frame and moves the photographing units and common frame together so as to two-dimensionally change photographing directions for the three-dimensional measurement. This aspect improves the accuracy of the three-dimensional measurement.

According to still another aspect of the present invention, the image transforming means related to the adjusting apparatus includes a frame memory configured to store the video signals, a positional information memory configured to store positional information of pixels, and a digital filtering data memory configured to read video signals from the frame memory and store the read video signals. The image transforming means sequentially write the video signals in the frame memory, store new positional information for pixels to convert in the positional information memory, and according to the new positional information in the positional information memory, transfer as and when needed a video signals related to regions used for digital filtering from the frame memory to the digital filtering data memory.

In this way, the projection display apparatus according to the present invention combines images displayed by the plurality of projection display units into a large composite image. Even on a nonplanar screen such as a concave spherical screen, the present invention may display high-quality, high-resolution images that are normally visible by audience.

For the projection display apparatus that combines images displayed by the projection display units into a large composite image, the adjusting apparatus according to the present invention enables high-quality, high-resolution images that are normally visible by audience to be displayed even on a nonplanar screen such as a concave spherical screen.

### BRIEF DESCRIPTION OF THE DRAWINGS

Having thus described the invention in general terms, reference will now be made to the accompanying drawings, which are not necessarily drawn to scale, and wherein:

FIG. 1 is a plan view showing an arrangement of a projection display apparatus according to an embodiment of the present invention.

FIG. 2 is a perspective view showing the projection display apparatus.

FIG. 3 is a front view showing image projection areas on a nonplanar screen where the projection display apparatus projects images.

FIG. 4 is a perspective view showing a projection display apparatus according to another embodiment of the present invention.

FIG. 5 is a front view showing image projection areas on a nonplanar screen where the projection display apparatus of FIG. 4 projects images.

FIG. 6 is a block diagram showing a geometric conversion unit in a projection display apparatus according to an embodiment of the present invention.

FIGS. 7A and 7B are front views showing geometric conversion conducted by the geometric conversion unit.

FIG. 8 is a block diagram showing a route from a video signal generator to a nonplanar screen in a projection display apparatus according to an embodiment of the present invention.

FIG. 9 is a block diagram generally showing a projection display apparatus with an adjusting apparatus according to an embodiment of the present invention.

FIG. 10 is a block diagram generally showing a projection display apparatus according to an embodiment of the present invention.

FIG. 11A is a perspective view showing a three-dimensional measurement conducted by a three-dimensional measuring unit in a projection display apparatus according to an embodiment of the present invention.

FIGS. 11B, 11C, and 11D are views from left camera, center camera and right camera, respectively, by means of three-dimensional measurement of FIG. 11A.

FIG. 12 is a block diagram showing a digital geometric converter of a geometric conversion unit in a projection display apparatus according to an embodiment of the present invention.

### DETAILED DESCRIPTION OF THE INVENTION

The present invention now will be described more fully hereinafter with reference to the drawings, in which preferred embodiments of the invention are shown. This invention may, however, be embodied in many different forms and should not be construed as limited to the embodiments set forth herein; rather, these embodiments are provided so that this disclosure will be through and complete, and will fully convey the scope of the invention to those skilled in the art. Like numbers refer to like elements throughout.

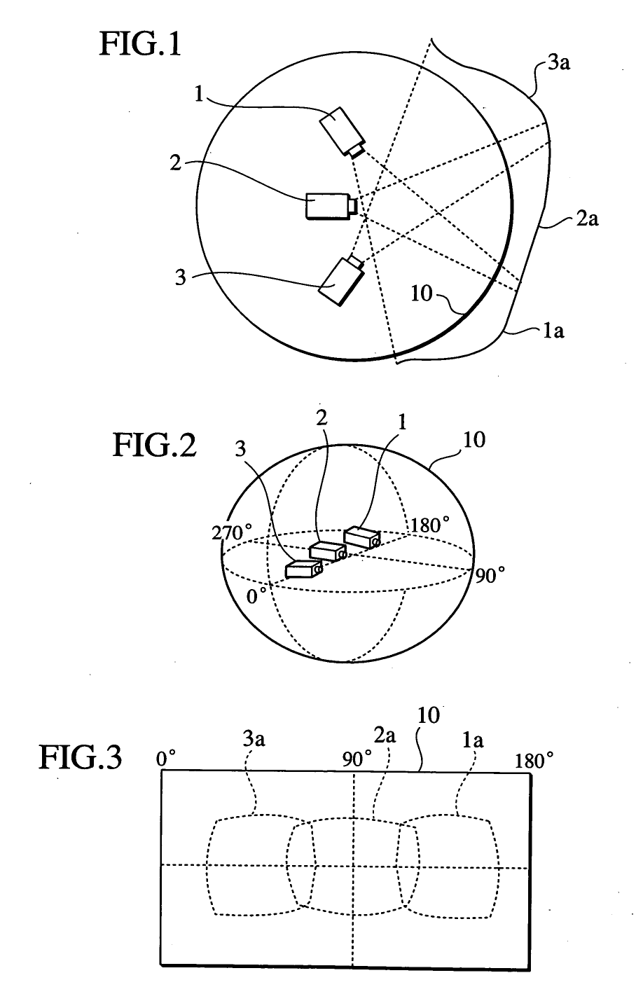

FIG. 1 is a plan view showing a projection display apparatus according to an embodiment of the present invention. This apparatus includes an adjusting apparatus according to an embodiment of the present invention. In FIG. 1, the projection display apparatus includes projectors 1, 2 and 3 serving as projection display units to project and display images according to supplied video signals. According to this embodiment, there are three projectors.

The projectors 1, 2 and 3 are, for example, liquid crystal projectors that are projection display units employing display devices (spatial light modulation elements) with pixels. Each of the projectors 1, 2 and 3 includes the display device, a light source with optical elements to illuminate the display device, and a projection lens (image forming lens) to project and display an image from the display device on a screen. The display device with pixels used for the projector may be a DMD (digital mirror device) instead of the liquid crystal display device.

The projection display apparatus also includes a nonplanar screen 10 to which the projectors 1, 2 and 3 project images. The nonplanar screen 10 may have the shape of a part of a concave spherical surface corresponding to an inner wall surface of one half of a true sphere. Preferably, the nonplanar screen 10 has a concave hemisphere shape. The shape of the nonplanar screen 10, however, is not limited to a part of a spherical surface. It may be a concave cylindrical surface or any other free curved surface. When the nonplanar screen 10 has a shape corresponding to a part of a concave spherical surface or any other shape, the vertical height of the nonplanar screen 10 may be narrower than the horizontal width thereof in consideration of a human view angle.

The projectors 1, 2 and 3 are arranged in the vicinity of the center of curvature of the nonplanar screen 10, or on a straight line passing through the center of curvature of the nonplanar screen 10 and the center of the nonplanar screen 10. For example, the projectors 1, 2 and 3 are arranged in a normal direction of the nonplanar screen 10, to prevent a contrast decrease.

FIG. 2 is a perspective view showing a typical arrangement of the projection display apparatus. In FIG. 2, the projectors 1, 2 and 3 are arranged in the vicinity of the center of curvature of the nonplanar screen 10 with the optical axes of projection lenses of the projectors being substantially horizontal. The projectors 1, 2 and 3 may be arranged such that the optical axes of the projection lenses thereof are differently oriented. For example, one of them is oriented to the center of the nonplanar screen 10, another of them to a right part of the nonplanar screen 10, and the remaining one to a left part of the nonplanar screen 10.

FIG. 3 is a front view showing areas of the nonplanar screen 10 to which the projectors 1, 2 and 3 project images. In FIG. 3, the projectors 1, 2 and 3 of the projection display apparatus project and display images in different image display areas on the nonplanar screen 10. The image display areas 1a, 2a and 3a slightly overlap each other. The image display areas 1a, 2a and 3a display a continuous composite image.

In each overlapping part of the image display areas, two of the projectors project the same image in an overlapping manner. If the projectors 1, 2 and 3 display images of the same intensity in the image display areas, the overlapping parts will show higher intensities than the other parts. To avoid this problem, the projection display apparatus according to the present invention makes the projectors 1, 2 and 3 substantially halve the intensities of image parts to be displayed in the overlapping parts. As a result, each overlapping part to which two of the projectors project the same image may have an intensity that is substantially equal to that of an image projected by a single projector. This process of adjusting the intensity of an overlapping part of the adjacent image display areas is called a blending process.

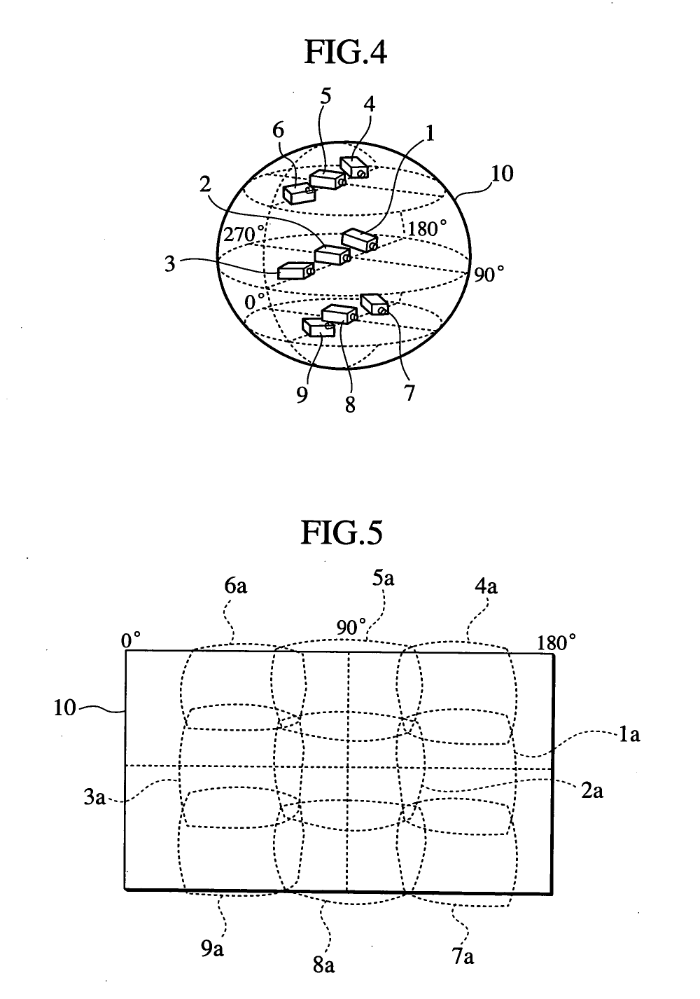

FIG. 4 is a perspective view showing a projection display apparatus according to another embodiment of the present invention. In FIG. 4, the projection display apparatus employs nine projectors including three middle-stage projectors 1, 2 and 3, three upper-stage projectors 4, 5 and 6, and three lower-stage projectors 7, 8 and 9.

FIG. 5 is a front view showing areas of a nonplanar screen 10 to which the projectors 1 to 10 project images. In FIG. 5, the projectors 1 to 9 project and display images in the different image display areas on the nonplanar screen 10. The adjacent image display areas slightly overlap each other. The image display areas 1a to 9a display a continuous composite image.

For each overlapping part of the adjacent image display areas, the same intensity adjusting process as that explained above is carried out. At each corner where four of the image display areas overlap, the intensity of each image to be displayed at the corner is substantially quartered. As a result, each corner to which four of the projectors project the same image may have an intensity that is substantially equal to that of an image projected by a single projector.

To prevent the contrast of images from decreasing, one idea is to arrange the projectors at the center of a sphere of the nonplanar screen 10 when the nonplanar screen 10 is a concave spherical screen. This may minimize repetitive reflection on the nonplanar screen 10, thereby preventing the contrast of images from decreasing.

When employing the projectors 1 to 9 to display a composite image on the nonplanar screen 10, geometric conversions must be conducted on images displayed by the projectors, to compensate distortions caused on the images by the nonplanar screen 10 and to display images without distortions.

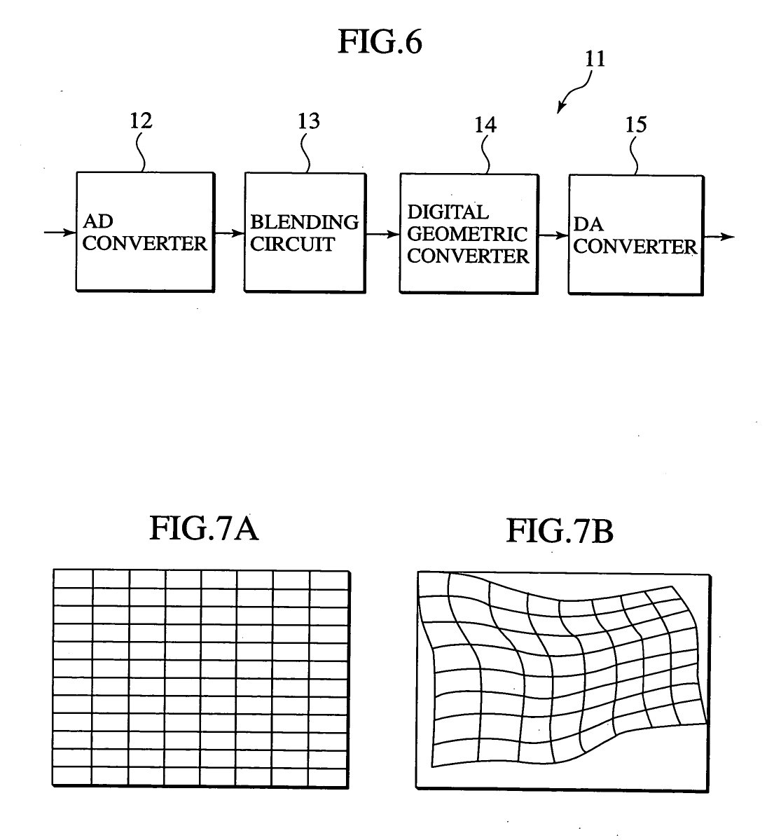

FIG. 6 is a block diagram showing a geometric conversion unit according to an embodiment of the present invention applicable to any one of the projection display apparatuss mentioned above. In FIG. 6, the geometric conversion unit 11 serving as image transforming means conducts geometric conversions on a video signal and supplies the converted signals to the projectors 1 to 9. The geometric conversion unit 11 includes an AD converter 12 for converting an input video signal into a digital signal, a blending circuit 13 for carrying out a blending process on an output signal of the AD converter 12, a digital geometric converter 14 for conducting a geometric conversion on an output signal of the blending circuit 13, and a DA converter for converting an output signal of the digital geometric converter 14 into an analog signal.

With the geometric conversion unit 11, the projection display apparatus can form a high-resolution composite image on the nonplanar screen 10. Namely, the geometric conversion unit 11 in the projection display apparatus changes the field angle of an image to display according to relationships among the positions of the projectors, the positions of image display areas of the nonplanar screen 10 where the projectors display images, and the position of an audience.

FIGS. 7A and 7B are front views showing a geometric conversion conducted by the geometric conversion unit 11 in the projection display apparatus. FIG. 7A shows a grid pattern based on a crosshatch video signal before geometric conversion. On this signal, a geometric conversion is conducted to provide a signal representing an image of FIG. 7B that is compensated for image distortions due to the nonplanar screen.

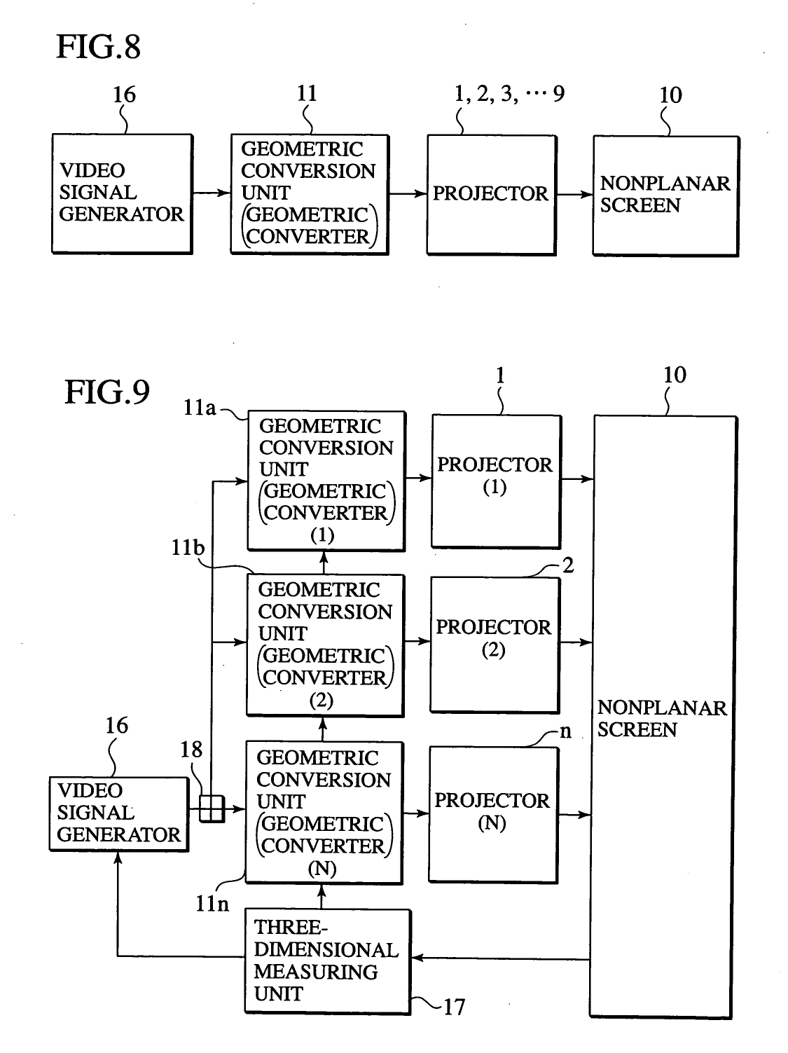

FIG. 8 is a block diagram showing a route from a video signal generator 16 to a nonplanar screen 10 in a projection display apparatus employing the geometric conversion unit 11. In the projection display apparatus, the image signal generator 16 supplies an image signal, which is passed through the geometric conversion unit 11 to projectors 1 to 9, which project and display images on the nonplanar screen 10.

FIG. 9 is a block diagram generally showing the projection display apparatus of FIG. 8. In FIG. 9, the projection display apparatus has an image dividing unit 18 that divides an incoming video signal from the image signal generator 16 into signals provided for a plurality of projectors 1 to n, respectively. The image dividing unit 18 supplies the divided signals to first to ‘n’th geometric converters 11a to 11n corresponding to the projectors 1 to n, respectively. The geometric converters 11a to 11n collectively form the geometric conversion unit 11 that provides image transforming means. Based on the divided video signals supplied by the image dividing unit 18, the geometric converters 11a to 11n change the field angles of images to display, according to relationships among the positions of the projectors 1 to n, the positions of areas on the nonplanar screen 10 where the projectors display images, and the position of an audience, thereby compensating distortions of images caused by the screen 10 that is nonplanar.

The projection display apparatus also has a three-dimensional measuring unit 17 that three-dimensionally measures images displayed by the projectors 1 to n. According to a result of the measurement, image transform quantities used by the geometric converters 11a to 11n are determined. Determining the image transform quantities in this way eliminates manual adjustments and forms a composite image on the nonplanar screen 10, the composite image being optimum when seen by audience. The three-dimensional measuring unit 17 consists of three monitoring cameras (video cameras) supported on a common frame that is movable. While the frame is being moved, the monitoring cameras can perform pan motion in left and right directions as well as tilt motion in up and down directions.

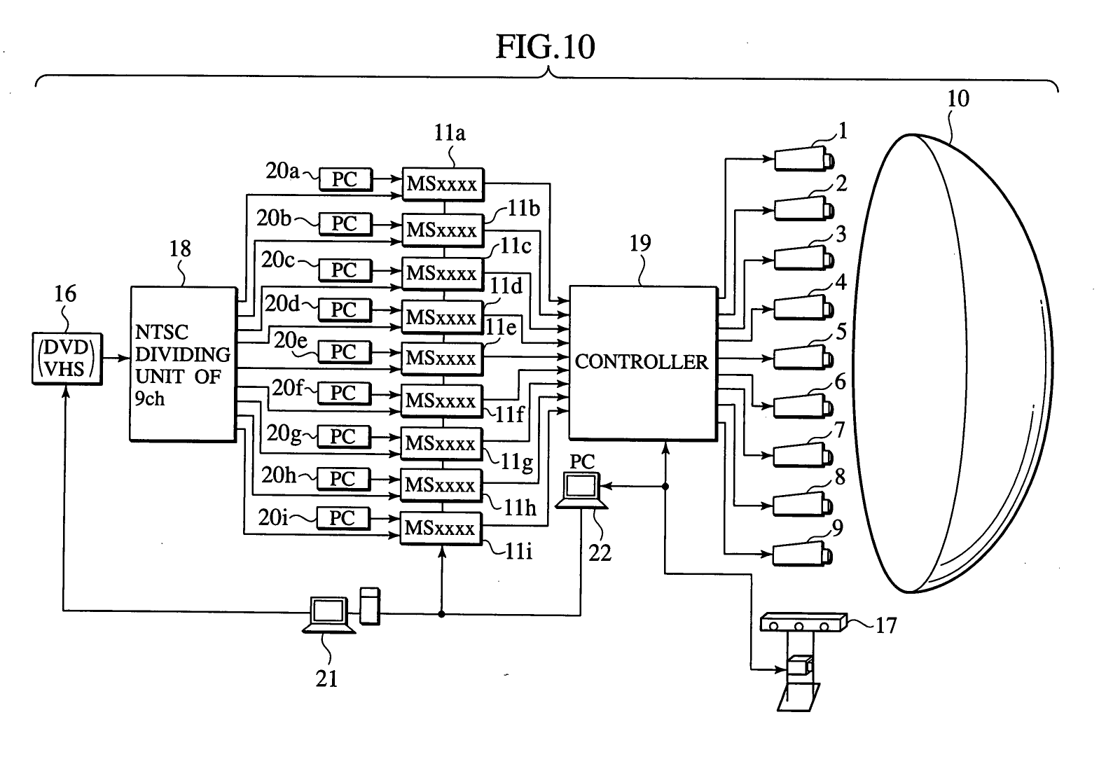

FIG. 10 is a block diagram generally showing a projection display apparatus according to an embodiment of the present invention. In FIG. 10, the projection display apparatus includes a video signal generator 16 which may be a DVD (registered trade name) disk player, a VHS (registered trade name) video player, or the like that outputs various video signals. The video signal generator 16 outputs a video signal, which is divided by an image dividing unit 18 or an NTSC dividing unit (nine channels) into signals, which are supplied to geometric converters 11a to 11i, respectively. The geometric converters 11a to 11i are controlled by personal computers (PCs) 20a to 20i, respectively. In addition, the geometric converters 11a to 11i are totally controlled by control PCs 21 and 22.

The geometric converters 11a to 11i provide video signals after conducting image conversions, and these video signals are sent to projectors 1 to 9 through a controller 19, to display images on a nonplanar screen 10.

A three-dimensional measuring unit 17 sends information photographed by monitoring cameras to the control PCs 21 and 22 and controller 19. According to the signal representative of a three-dimensional measurement result from the three-dimensional measuring unit 17, the control PCs 21 and 22 control the geometric converters 11a to 11i.

When displaying a composite image with the projectors 1 to 9 in the projection display apparatus, the video signal generator 16 first provides a positional information measuring pattern (for example, a crosshatch signal representative of map data) to the projectors 1 to 9, which display the pattern as it is on the nonplanar screen 10 without conversions by the geometric converters 11a to 11i. For the positional information measuring pattern, the three-dimensional measuring unit 17 conducts a three-dimensional measurement.

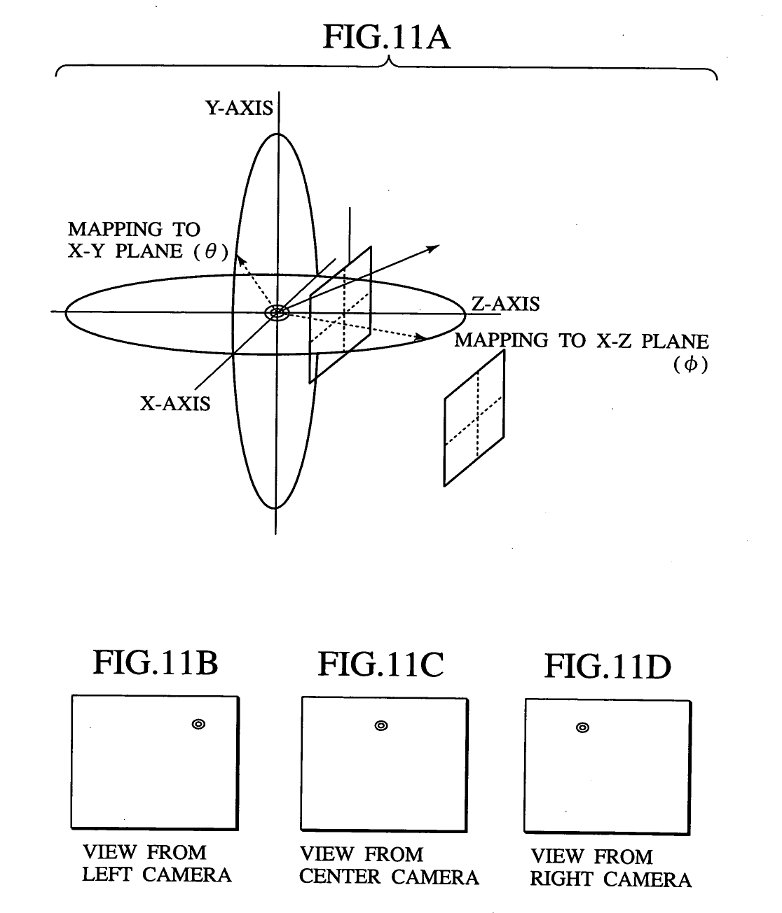

FIG. 11A is a perspective view showing the three-dimensional measurement conducted by the three-dimensional measuring unit 17. In FIG. 11A, the three-dimensional measurement measures a given target on the positional information measuring pattern and provides polar coordinate information (φ, θ) and distance information D relative to the eye points of the monitoring cameras. The projection display apparatus accurately conducts such a three-dimensional measurement according to operations using parallaxes among the three monitoring cameras as shown in FIGS. 11B, 11C and 11D.

The monitoring cameras with the frame can collectively perform pan motion in left and right directions as well as tilt motion in up and down directions, to correctly accomplish a three-dimensional measurement.

According to a result of three-dimensional measurement, the control PCs 21 and 22 prepare geometric conversion map data for controlling the geometric converters 11a to 11i in such a way as to optimize the positions of projected images. Then, the geometric converters 11a to 11i automatically carry out image transform processes.

In addition to the result of the three-dimensional measurement, an operation based on the positional information of an audience is conducted to form a composite image in which adjacent images agree with each other pixel by pixel when seen by audience and which has natural perspective. The position of the audience is not limited to the center of curvature of the nonplanar screen 10. It is preferable to make it closer to the nonplanar screen 10 to give the audience much presence.

The positional information of an audience may be gathered by setting the three-dimensional measuring unit 17 at the position of the audience, or by assuming virtual positional information for the three-dimensional measuring unit 17. Namely, a display image seen from the position of an audience may be normalized without considering the

As explained above, the projection display apparatus according to the present embodiments provides the projection display units with video signals passed through the image transforming means and makes the projection display units project and display images on a nonplanar screen according to the video signals. The images displayed with the projection display apparatus are of high quality and high resolution and can normally be seen by audience.

According to the projection display apparatus of the present embodiments, the nonplanar screen has a shape that is a part of a sphere, and the projection display units are arranged in the vicinity of the center of curvature of the nonplanar screen, or on a straight line passing through the center of curvature of the nonplanar screen and the center of the nonplanar screen. This arrangement minimizes repetitive reflection on the nonplanar screen to prevent the contrast of displayed images from deteriorating.

The projection display apparatus according to the present embodiments employs the adjustive signal generator (the video signal generator 16) to make the projection display units project adjustive images to the nonplanar screen, the three or more photographing units to photograph the projected adjustive images, the measuring unit to three-dimensionally measure the projected images according to video signals provided by the photographing units, and the transformation processors (PCs) to provide the image transforming means with image transforming information based on a measurement result provided by the measuring unit. This projection display apparatus is capable of displaying high-quality, high-resolution images that are normally seen by audience.

The adjusting apparatus according to the present embodiments supports the three or more photographing units on a common frame. When conducting a three-dimensional measurement, the photographing units and frame are moved together to change a photographing direction vertically and horizontally.

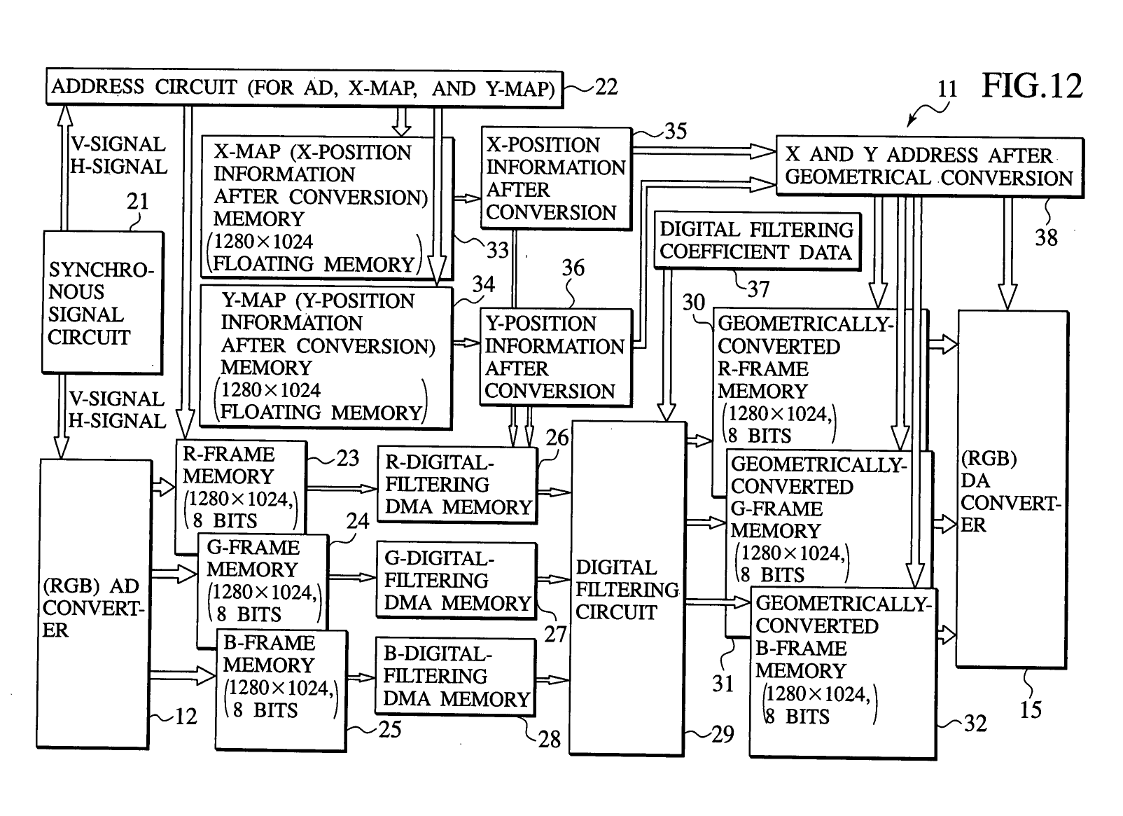

FIG. 12 is a block diagram showing a digital geometric converter of a geometric conversion unit in a projection display apparatus according to an embodiment of the present invention.

An arrangement of the digital geometric converter 14 of the geometric conversion unit 11 will be explained in detail in connection with an SXGA video signal.

In FIG. 12, the digital geometric converter 14 has a synchronous signal circuit 21. The synchronous signal circuit 21 separates an incoming video signal into a V-signal and an H-signal that are used for a write operation into frame memories. The V- and H-signals separated by the synchronous signal circuit 21 are input to an AD converter (RGB AD converter) 12 and an address circuit 22. The AD converter 12 provides digital video data that is sequentially written in frame memories 23, 24 and 25 (each being, for example, a 1280×1024, 8-bit memory) for R, G and B, respectively. The video data written in the frame memories 23, 24 and 25 are read by digital filtering DMA memories 26, 27 and 28 for R, G and B, respectively. The digital filtering DMA memories 26, 27 and 28 conduct, as and when needed, block processes to read, from the frame memories 23, 24 and 25, only data that are used by a digital filtering circuit 29 to be explained later.

The video data read out of the digital filtering DMA memories 26, 27 and 28 are sent to the digital filtering circuit 29. The digital filtering circuit 29 processes the pre-conversion video data and provides post-conversion video data. The post-conversion video data provided by the digital filtering circuit 29 is sequentially written in geometrically-converted frame memories 30, 31 and 32 (each being, for example, a 1280×1024, 8-bit memory) for R, G and B.

The post-conversion video data in the geometrically-converted frame memories 30, 31 and 32 are always read under the control of a read circuit and the read data are transferred to a DA converter (RGB DA converter) 15.

The address circuit 22 generates a clock signal used by the AD converter 12 and controls write addresses of the frame memories 23, 24 and 25.

In addition, the address circuit 22 controls an X-map memory 33 and a Y-map memory 34 (each being, for example, a 1280×1024 floating memory) serving as positional information memories. The X-map memory 33 and Y-map memory 34 store new X-position 35 and Y-position 36 that are positional information for converted pixels. The data in the X-map memory 33 and Y-map memory 34 are floating data. This is because a geometric conversion mostly makes the new X-position 35 and Y-position 36 deviate from the center of an image.

According to an address count supplied from the synchronous signal circuit 21, the X-map memory 33 and Y-map memory 34 provide the converted new X-position 35 and Y-position 36. Based on the X-position 35 and Y-position 36, the digital filtering DMA memories 26, 27 and 28 conduct DMA processes to read, as and when needed, only data around the X-position 35 and Y-position 36 to be used by the digital filtering circuit 29.

The floating data in the X-map memory 33 and Y-map memory 34 are also used to select coefficient data 37 for the digital filtering circuit 29.

The digital filtering circuit 29 reads, according to the numbers of horizontal and vertical taps, the coefficient data 37 that is switchable according to a geometrical transform ratio. The coefficient data 37 is used to carry out multiplication and add operations on RGB pixels, and resultant data is subjected to dividing operations to generate new pixel data.

Video data consisting of the new pixel data thus generated are written in the geometrically-converted frame memories 30, 31 and 32. Addresses used at this time for the memories 30, 31 and 32 are the new X-position 35 and Y-position 36 read out of the X-map memory 33 and Y-map memory 34. Namely, the new X-position 35 and Y-position 36 read out of the X-map memory 33 and Y-map memory 34 are used as geometrically-converted X and Y addresses 38, to write the geometrically-converted video data in the frame memories 30, 31 and 32. The addresses of the memories 30, 31 and 32 are integer addresses. Accordingly, the floating data in the X-map memory 33 and Y-map memory 34 are converted into binary data and are used as the geometrically-converted X and Y addresses 38 serving as write addresses for the memories 30, 31 and 32. The X and Y addresses 38 are also supplied to the DA converter 15.

That which is claimed:

1. A projection display apparatus comprising:
a plurality of projection display units for projecting and displaying images based on supplied video signals;
a nonplanar screen to which the projection display units project the images;
an image dividing unit for dividing an incoming video signal into divided video signals for the projection display units, respectively; and
image transforming means for changing the field angle of images represented with the divided video signals according to relationships of the position of the corresponding projection display units, the position of areas of the nonplanar screen to which the corresponding projection display units project the images, and the position of an audience, wherein
each of the projection display units receive the changed video signal from the image transforming means and projectes an image to the nonplanar screen according to the received video signal.

2. The projection display apparatus of claim 1, wherein
the nonplanar screen corresponds to an inner wall surface of a substantial hemisphere; and
the projection display units are arranged in the vicinity of the center of curvature of the nonplanar screen, or on a straight line passing through the center of curvature of the nonplanar screen and the center of the nonplanar screen.

3. The projection display apparatus of claim 1, wherein
the image transforming means have a frame memory configured to store the divided video signals, a positional information memory configured to store positional information of pixels, and a digital filtering data memory configured to read video signals from the frame memory and store the read video signals; and
the image transforming means sequentially write the divided video signals in the frame memory, store new positional information for pixels to convert in the positional information memory, and according to the new positional information in the positional information memory, transfer as and when needed video signals related to regions used for digital filtering from the frame memory to the digital filtering data memory.

4. An adjusting apparatus for adjusting an image transforming quantity of the image transforming, employed for a projection display apparatus having projection display units for projecting and displaying images according to supplied video signals, a nonplanar screen to which the projection display units project the images, and image transforming means for changing the field angle of images to display according to relationships of the position of the projection display units, the position of areas of the nonplanar screen to which the projection display units project the images, and the position of an audience, comprising:
an adjustive signal generator for generating an adjustive signal according to which the projection display units project adjustive images to the nonplanar screen;
a plurality of photographing units for photographing the projected adjustive images;
a measuring unit for three-dimensionally measuring the projected adjustive images according to video signals provided by the photographing units; and
a transformation processor for providing the image transforming means with image transforming information based on a measurement result provided by the measuring unit.

5. The adjusting apparatus of claim 4, wherein
the plurality of photographing units are supported on a common frame and are configured to be moved together with the frame so as to two-dimensionally change photographing directions for the three-dimensional measurement.

6. The adjusting apparatus of claim 4, wherein
the image transforming means include a frame memory configured to store the video signals, a positional information memory configured to store positional information of pixels, and a digital filtering data memory configured to read video signals from the frame memory and store the read video signals; and
the image transforming means sequentially write the video signals in the frame memory, store new positional information for pixels to convert in the positional information memory, and according to the new positional information in the positional information memory, transfer as and when needed video signals related to regions used for digital filtering from the frame memory to the digital filtering data memory.
